(19) United States
(12) Patent Application Publication
(10) Pub. No.: US 2013/0073352 A1
(43) Pub. Date: Mar. 21, 2013

(54) DYNAMIC GROUP DISCOUNTING

(71) Applicants: Jonathan Perkins, San Francisco, CA (US); Julian Balderas, San Francisco, CA (US)

(72) Inventors: Jonathan Perkins, San Francisco, CA (US); Julian Balderas, San Francisco, CA (US)

(21) Appl. No.: 13/619,358

(22) Filed: Sep. 14, 2012

Related U.S. Application Data
(60) Provisional application No. 61/535,145, filed on Sep. 15, 2011.

(51) Int. Cl. G06Q 30/02

(52) U.S. Cl. 705/14.1

(57) ABSTRACT

A system and method for sellers to provide dynamic group discounting to buyers of products and/or services is provided. The system and method allows a seller to determine discount parameters that will be applied to a quantity of goods and/or services to be sold. A purchaser agrees to pay full price for the goods and/or services and may later be provided with a unique discount relative to other purchasers based in part on when the purchaser bought the goods and/or services during the sale period. The system and method may utilize a discount curve to determine the amount of the discount each individual purchaser, or groups of purchasers, will receive.

### PRIORITY

The present application claims the benefit of U.S. Provisional Patent Application Ser. No. 61/535,145 filed Sep. 15, 2011, which is incorporated herein by reference in their entirety.

### THE FIELD OF THE INVENTION

The present invention relates to commerce utilizing the internee and more particularly to a system and method for sellers to provide dynamic group discounting to buyers of products and/or services.

### BACKGROUND

The World Wide Web has provided a convenient mechanism for marketing products. Many web sites offer products for sale. Generally a potential customer viewing such a web site indicates a desire to buy a particular product by “clicking” on a particular location on the display screen. There are a variety of methods currently available for conducting a business transaction on a web site. Some web sites allow a buyer to bid on products that are offered in the internees equivalent of an auction. Other web sites allow a user to make an offer to buy products at a price specified by the buyer, much as an individual might make an offer to buy a product at a particular price in a face to face situation. Still other web sites allow a user to specify a price at which he or she is willing to purchase a product and allows the seller, or group of sellers, determine whether they will accept the offer an fulfill the purchase request.

Web sites such as those described above in essence utilize the internet to automate a conventional buying process. The process takes place at great speed and the parties may be remote, but the fundamental transaction is conventional.

However, each of the methods of conducting business may have inherent disadvantages. For example, if the seller sets the price at which a product is to be purchased, he or she may not be certain of the demand for the product at that price. If the price for the product is set too high, than only a few, or maybe no, units of the product may be sold as compared if the price was discounted. An auction web site may be ideal for sellers wanting to sell a single item having multiple buyers bidding on the price, but may not be as well suited for sellers wanting to sell large quantities of goods to multiple buyers. Websites that facilitate transactions based on the buyer setting the price he or she is willing to pay also have disadvantages, i.e. sellers may be willing to sell products at lower than normal prices, uncertainties involved with whether a buyer's offer will be accepted, etc.

There is thus a need for an improved method and system for sellers to market goods and/or services at a discounted price while reducing the seller's risk and maximizing the seller's profit that provides adequate incentive to potential buyers. Such a method and system should provide dynamic discounting.

### SUMMARY OF THE INVENTION

It is an object of the present invention to provide an improved method and system for sellers to provide dynamic group discounting to buyers of products and/or services.

According to one aspect of the invention, the improved method and system allows sellers to market products and/or services at a discounted price to consumers while reducing risk and maximizing profit.

According to another aspect of the invention, the system and method allows a seller to input information regarding products and/or services to be sold. The information may include the quantity of a product and/or service to be sold, the price at which the product and/or service will be offered for sale, the time limit for which the product and/or service will be offered for sale (i.e. the sale period), and/or the discount parameters to be applied to the purchase of the product and/or services According to another aspect of the invention, the discount parameters may include a discount curve.

According to still another aspect of the invention, the discount parameters may include the overall discount amount that will be applied for a given sale period.

According to yet another aspect of the invention, a plurality of purchasers agree to pay full price for the goods and/or services and may later be provided with a unique discount relative to other purchasers based in part on when the purchaser bought the goods and/or services during the sale period.

According to another aspect of the invention, the system and method may provide an incentive for buyers to share and/or promote the sale of a particular product and/or service to increase the overall sales of the product and/or service.

In accordance with another object of the invention, the discount can be set up so that a purchaser's price is affected by each subsequent individual buyer, or by tiers or groups of purchasers, making it more of a threshold type of discounting run. Additionally, the tiers could be either fixed or variable.

In accordance with another object of the invention, there may be a variety of options for providing a discount to buyers. For example, a simple refund may be provided to the buyer shortly after the close of the sale, a delayed charge system may be utilized, the discount value could be given as a credit towards future purchases or goods with the same merchant or given as other benefits, etc.

In accordance with still another aspect of the invention, the system and method of the present invention may provide additional incentives for buyers to share the sale when they refer subsequent purchasers.

In accordance with yet another aspect of the invention, there may be variations of the dynamic discounting system and method that would allow a purchaser to jump ahead in line, such as by referring a certain number or quota of individuals defined by the merchant.

These and other aspects of the present invention are realized in an improved method and system for sellers to provide dynamic group discounting to buyers of products and/or services as shown and described in the following figures and related description.

### BRIEF DESCRIPTION OF THE DRAWINGS

Various embodiments of the present invention are shown and described in reference to the numbered drawings wherein:

FIG. 1 shows a system in accordance with the present invention, in simplified block diagram;

FIG. 2 shows a flowchart for system and method for sellers to provide dynamic group discounting to buyers of goods and/or services;

FIG. 3 shows another flowchart for sellers to provide dynamic group discounting to buyers of products and/or services;

FIG. 4 shows a spreadsheet and graph according to the dynamic group discounting system and method of the present invention;

FIG. 5 shows a spreadsheet and graph according to the dynamic group discounting system and method of the present invention;

FIG. 6 shows a spreadsheet and graph according to the dynamic group discounting system and method of the present invention;

FIG. 7 shows a spreadsheet and graph according to the dynamic group discounting system and method of the present invention;

FIG. 8 shows various discount curves that can be used to calculate a discount according to principles of the present invention; and

FIG. 9 also shows various discount curves that can be used to calculate a discount;

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

As used herein, “dynamic group discounting” relates to commerce, online purchasing, presales, product launches, product promotion etc. Dynamic group discounting is an effective way for consumers to save money while sellers can minimize risk and maximize profit when selling larger quantities of items, multiple items and/or services, etc., at discounted pricing.

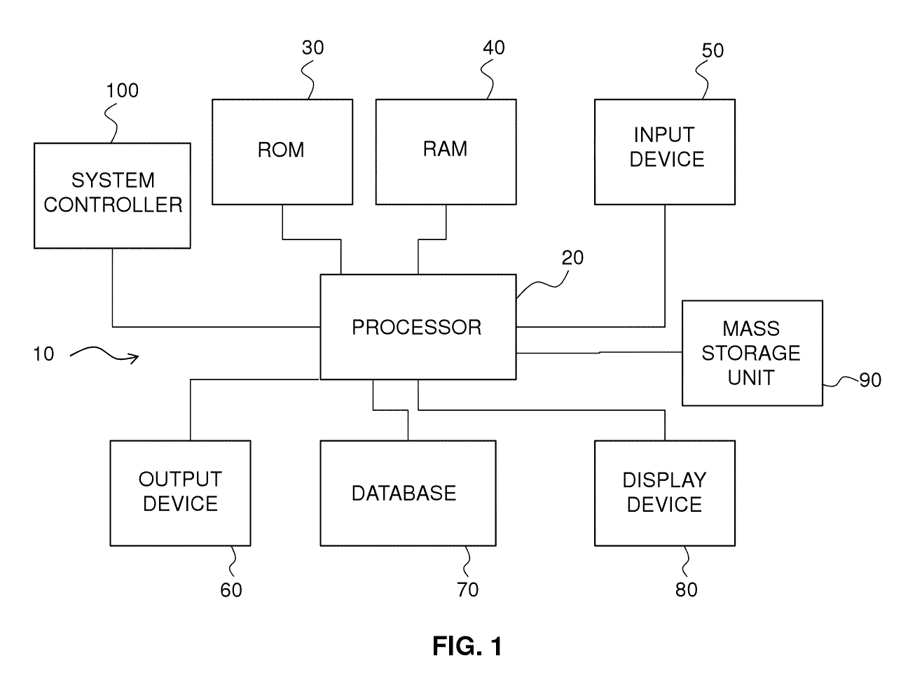

Turning now to FIG. 1, a simplified block diagram representation of a terminal 10 for use in a system and method in accordance with the present invention is shown. The figure does not necessarily show all of the system's hardware and software modules, and omits many physical and logical connections which will be apparent to one of ordinary skill in the art after review of the present disclosure. The terminal 10 can be a special purpose data processor, a general-purpose computer, a computer system, or a group of networked computers or computer systems configured to perform the steps or modes of the methods of the invention. According to one aspect, the terminal 10 may built on a personal computer platform, such as a PC or a Mac computer. According to another aspect, the terminal 10 may communicate with a system controller 100. The system controller 100 can be a computer network within a client/server environment. According to yet another aspect, the system and method of the present invention may be implemented on the Internet, an intranet or an extranet.

The terminal 10 may be connected to a system controller 100 which is programmed to execute instruction causing it to perform various steps of the methods described below, receiving the inputs and producing the results as indicated. It will be appreciated that one or more terminals 10 may be connected to the system controller so as to allow sellers and buyers to transact business from separate locations. The instructions may take the form of program code embodied in tangible media, such as hard drives, floppy diskettes, CD-ROMS, DVD, or any other machine-readable storage medium. The program code can also be transmitted over a transmission medium, for example, over electrical wiring or cabling, through fiber optics, through the Internet, wirelessly, or via any other form of transmission.

With reference to FIG. 1, the s terminal 10 may include a processor 20 that can communicate with the system controller 100 which performs the processing routines and control functions of the methods in accordance with the invention. The terminal 10 may also include memory arrays 30 and 40, and a mass storage device 90. In the illustrated embodiment, the memory array 30 is a read only memory (ROM) device, the memory array 40 is a random access memory (RAM) device, and the mass storage device 90 is a magnetic disk drive, or a conventional hard drive. The mass storage device 90 and each of the memory arrays 30 and 40 may be connected to the processor 20.

A user input device 50 is used to enter data or commands using the terminal 10. The input device 50 can include, for example, the following mechanisms: a keyboard; a scanner; a user pointing device such as, for example, a mouse, a trackball, or a touch pad. As illustrated in FIG. 1, the user input device 50 may connected to the processor 20. The user input device 50 may be connected to the processor 20, for example, directly or through a local area network (LAN), through a wide area network (WAN) through a wired or wireless network, through the Internet, an intranet or an extranet.

Alternatively, the terminal 10 may also include a database 70 for storing the data that may be needed or desired in performing the method steps described herein. The database 70 can be a physically separate system coupled to the processor 20, as illustrated. In one version of the system 10, the processor 20 and the mass storage device 90 perform the functions of the database 70.

The terminal 10 can further include one or more output devices, for example, a display 50 and a printer 80. The one or more output devices may be located in a different location than the processor 20 and may be connected to the processor 20, for example, directly or through a local area network (LAN), through a wide area network (WAN) through a wired or wireless network, through the Internet, an intranet or an extranet. As explained above, the terminal 10 may be connected to a system controller 100

According to one aspect of the invention, the terminal 10 may be used by sellers to provide dynamic group discounting to buyers of products and/or services. As mentioned above, a number of different systems may be connected to a system control 100 which may allow a single seller to provide products and/or services to a plurality of buyers, each of the seller and the plurality of buyers communicating with each other through the system control 100.

The present invention may provide a risk-free solution for discounting sale items of limited quantity. For example, deep discounting may begin only when a large percentage of the items have been sold, and each purchaser (or groups of purchasers) may receive a discount that is of a slightly different value. This may solve the risk problem in a way that also keeps consumers engaged in promoting the deal to their friends throughout the sale period after they have made their purchase. As explained in more detail below, if a person is an early purchaser of an item, it will be in their direct interest to encourage more people to also purchase the product and/or service after them, because the subsequent purchases may increase the amount of the discount the early purchaser receives for the product and/or service. In other words, when someone purchases an item of limited quantity, or during a discounting sale of limited time, they agree to pay at full price, however they understand that if more people purchase the same item and/or service thereafter then he or she will end up paying a lower rate at the end of the sale. It will be appreciated that the early purchase may receive additional benefit through delayed payment, refunds or other compensation.

The discount selling system and method of the present invention may be used for products and/or services of limited quantity, or for products and/or services sold during a fixed amount of time. According to one aspect of the invention, during the length of a sale, a purchaser may agree to buy an item at full price, however, the price may be reduced incrementally for each subsequent purchase until the close of the sale. The outcome of this is that each buyer of the product or service may be charged a final price that is different from each other buyer at the close of the sale. The sale can be defined by the quantity of items sold, the duration of time that the sale is offered, or both. According to another aspect of the invention, the factors that may determine each purchaser's final price are: starting full price, order in which item is purchased (e.g. 1st, 2nd, 3rd . . . Nth buyer), the total number of buyers, discount parameters set by the seller applied to the sale of the product and/or service (e.g. overall discount and/or the formula or shape of the discount curve applied to the sale of the product and/or service, etc.

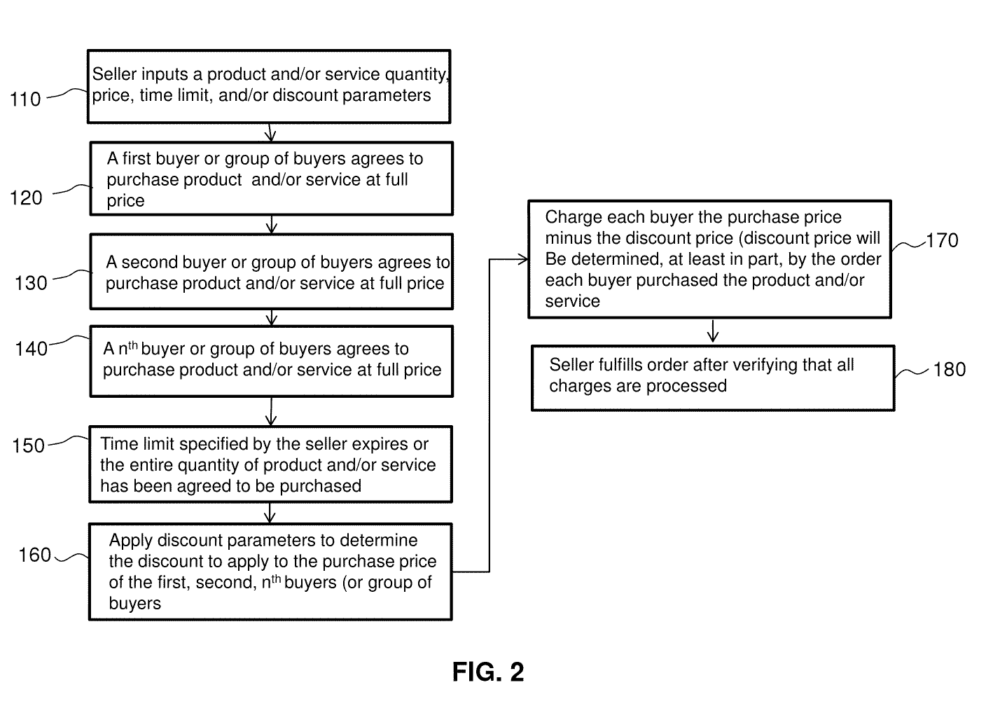

Turning now to FIG. 2, a flowchart for sellers to provide dynamic group discounting to buyers of products and/or services is shown. It will be appreciated that the flowchart of FIG. 2 is exemplary only and that particular steps may be omitted and/or additional steps added according to principles of present invention. According to step 110 a seller may inputs information about a product and/or service which is communicated to the system control 100 shown in FIG. 1.

Typically, the seller will enter discount parameters which will determine what overall discount he or she provides to buyers, and the shape of the discount curve (or formula) that will be used to determine the discount price that will be given to each individual buyer of the product and/or service. This can be anywhere from <1% to >99%, but for practical purposes sellers may only provide discounts ranging from about 10% to 40%. However, this total discount amount may only be given in full if all items are sold by the close of the sale. If a lesser number of items are sold, then the overall discount maybe less, as no buyer will have reached the lower part of the discount curve. This enables the seller to offer discounts without the risk of losing profits if demand for the product does not turn out to be high. In step 110, the seller may also specify the amount of product and/or service available, the starting full price of the product and/or service and the time remaining until close of sale. At step 120 through 140 a number of potential buyers may agree to purchase the product and/or service at full price. Each buyer will purchase the product and/or service at a unique time period during the duration of the sale period set by the seller. For example, a first buyer agrees to purchase the product and/or service at full price early in the sale period at step 120. Subsequently a second buyer agrees to purchase the product and/or service at full price. This process continues with Nth number of buyers until the time limit for to sale specified by the seller expires or the entire quantity specified by the seller has been agreed to be purchased by buyers at step 150.

Once the sale period has ended, the system controller 100 (FIG. 1) may calculate the unique discount that will be applied to each of the buyers purchase price at step 160. The price charged to each individual buyer at step 170 may include a unique discount price. Alternatively, a unique discount price may be applied to different groups of buyers. For example, the first 10 buyers may receive a first discount price, buyers 11-20 may receive a second discount price, etc. Regardless of whether a unique discount price is applied to each individual buyer or to groups of buyers, the earliest purchases during the sale period will receive the largest discount and the last purchase the smallest discount, with a range of discount prices being applied to the purchase price for those buyers who buy at some time after the earliest purchasers, but before the last purchasers.

At step 180, the seller then fulfills the orders received from the buyers. The seller may wait to fulfill the orders, or an order, until verification that the charged price for a particular buyer has properly processed.

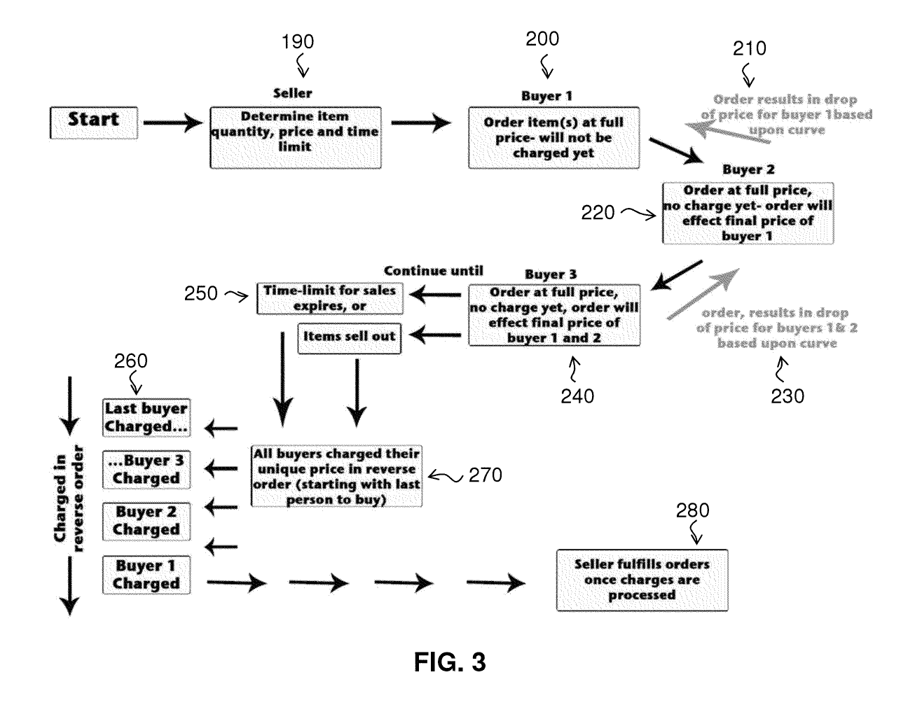

Turning now to FIG. 3, another flowchart for sellers to provide dynamic group discounting to buyers of products and/or services is shown. The flowchart shown in FIG. 3 shows a similar system as shown in FIG. 2, thus several elements shown in FIG. 3 may not be discussed in detail as they have been explained above. The flowchart in FIG. 3 shows how a system of the present invention may provide discount information for individual buyers in real time. For example, when a buyer agrees to purchase an item at full price at step 220 after another buyer has already agreed to purchase the item at step 200, information may be provided to the buyer from step 200 regarding the current discount price he or she will receive assuming no other subsequent buyers purchase the item before the sale period ends (step 210).

It will be appreciated, however, that the discount price may change as the sale progresses if subsequent buyers do purchase the item during the sale period. For example, if a third buyer agrees to purchase the item at full price, information may be provided at step 230 to both the first buyer (step 200) and the second buyer (step 220). Thus, the overall price or final price of the item (i.e. the full price minus the discount price) is lowered incrementally with each customer's, or groups of customers', subsequent purchase. The earlier a customer buys, the more discounting he or she will receive upon sellout of the items or expiration of the sale period. So, the first purchaser to buy receives the greatest discount, and the last person to buy receives the least; all purchasers in between receive a discount between these two points, based on the order in which they purchased. If the entire quantity sells out, then the overall cost of all items is discounted at the rate decided upon at the beginning of sale.

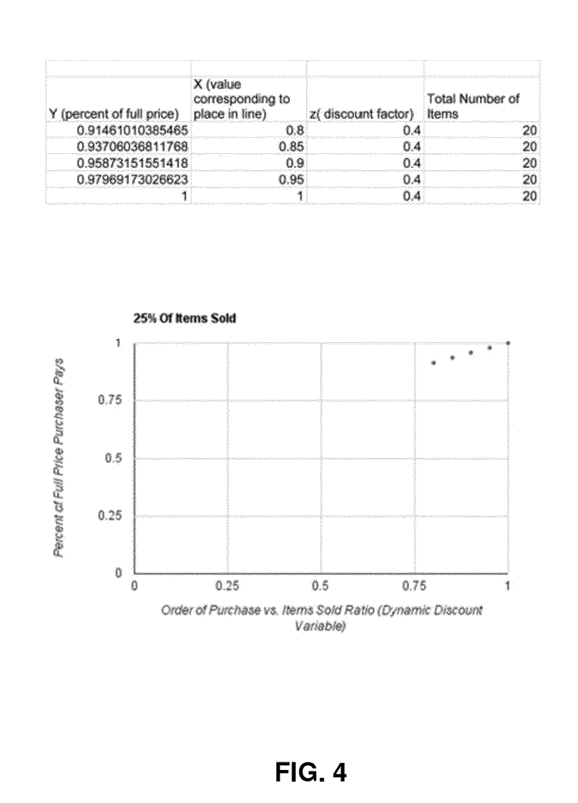

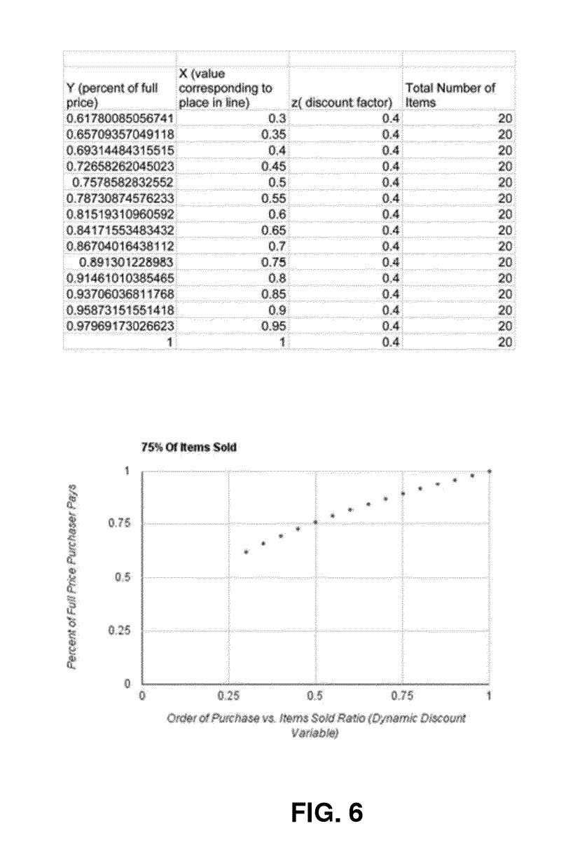

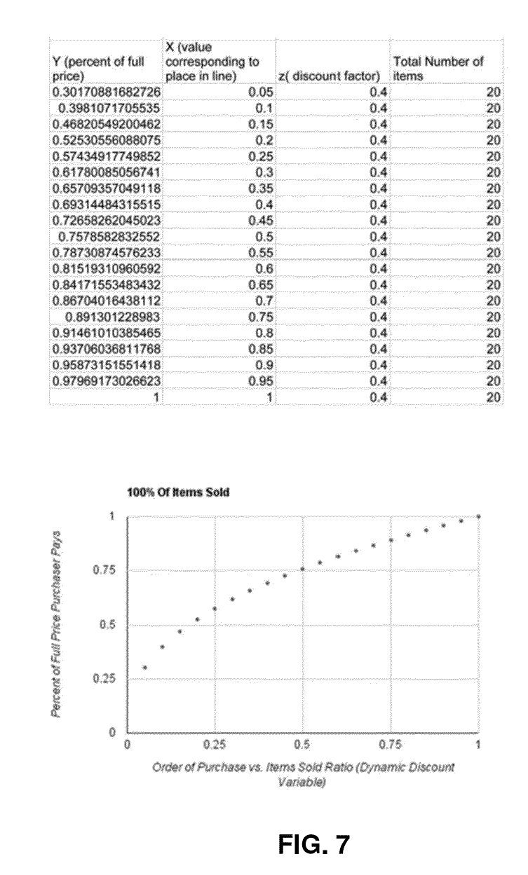

Several examples of discount graphs (with accompanying spreadsheets to provide additional clarity) have been provided in FIGS. 4 through 7. In the graphs, the x-axis is representative of the order in which a buyer purchases a product and/or service out of the total items available, and how many have been purchased before and/or after (this value is also referred to as the dynamic discount variable in the attached figures). The y-axis is representative of the percent of full price that will be paid (i.e. the full price minus the discount price). When a person buys an item, he or she always start at the upper right of the graph and moves down and/or to the left incrementally with each subsequent purchase. The earlier a customer buys the product and/or service, the further the customer can potentially go into the region where the steepest discounting happens.

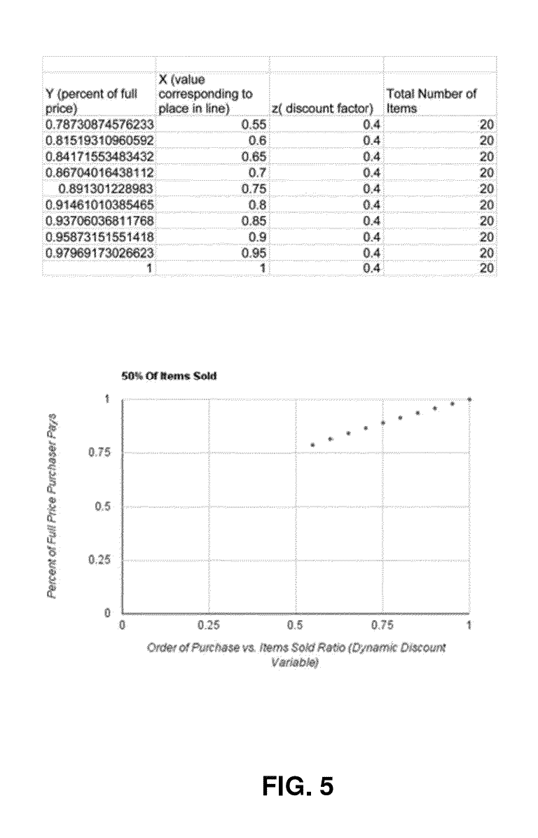

If not all the items are sold, no purchasers may reach the lowest point of the discount curve. For example, if only 50% of items sell, the discount curve may only be populated on the right half. (See e.g. FIG. 5). This may create “risk free discounting” for sellers, meaning that only if they sell close to all of the items do they provide steep discounts for certain buyers. So, if all items are sold, the first person to buy ends up at the bottom left of the curve, receiving the maximum discount price, and the last person to buy ends up at the top right of the curve, paying closest to full price, and everyone else pays a price in between the two extremes. The sum total of the discounts is set by the seller.

In one embodiment the discount may based on the equation y=x^{z} where y is representative of the discount given (i.e. a percentage of full price) or total item cost. The x may represent the dynamic discount variable calculated as (purchaser's place in line plus the number of remaining available items)/(total number of items on sale). The z may represent the discount factor from 0, exclusive, to 1, inclusive, selected by the merchant to define the desired discount. For illustrative purposes only, spreadsheets and graphs have been provided in FIGS. 4 through 7 that have be derived from the general equation y=x^{0.4}, The formula y=x^{0.4} gives approximately a 30% overall discount if all items are sold.

In FIGS. 4 through 7 the y-axis represents the percent of full price to be paid for the item purchased (the top of the y-axis would be 100% of the full price (i.e. no discount) and the bottom of the y-axis would be 0% of the full price (i.e. 100% discount). The x-axis represents a value corresponding to the order in which purchasers agree to buy a product and/or service during a sale period and shows how many people have purchased. This may be calculated simply as order of purchase (1^{st} to buy, 200^{th} to buy, etc.) plus the remaining number of items available, all divided by the total number of items on sale. This may normalize the dynamic discount variable so that it has a formula regarding of the total number of items to be sold. For example, if there are 1000 items available, everyone starts out at the right side of the graph and is bumped towards zero incrementally for each person (or units of people) that purchase subsequently.

The range that a purchaser is able to travel towards the origin is limited by the quantity of items available, thus, if there are only 50 remaining items when they purchase, a maximum of 49 people can purchase afterwards, making it possible to only travel a portion of the way to the left on the x axis. It will be appreciated that whatever curve is input (y=x^{0.4}, for example), x is calculated by [(place in line+number of remaining items)/total number of items], and y is the corresponding value of the discount (% of full price) based on whatever curve is being used.

For example, if 1000 items are on sale and John is the 9th purchaser, and 100 people purchase after John, then there are 891 items remaining. John's price is calculated as y=[(9+891)/1000]^{0.4}=0.96, or 96% of full price (4% discount). If 550 people purchase after John, then his price is y=[(9+441)/1000]^{0.4}=0.73, or 73% of full price (27% discount). If all items are sold, John's price is y=[(9+0)/1000]^{0.4}=0.15, or 15% of full price (85% discount).

FIGS. 4 through 7 illustrate a sale of 20 items, at various stages of sellout (25%, 50%, 75% and 100%). The data grid area shows each purchaser's price (y) based upon their place in line and how many items are remain out of the total (x); each is represented by a value between 0 and 1. In each example, the equation, or curve, is y=x^{0.4}. The graph is a visual representation of how many purchasers have bought, and what their price is based upon their place in line. Note that in each stage, the last person to buy always has the price closest to 100%, and the earlier purchasers' price is lowered as the items sell out. Also note that only when the sale becomes close to sold out do any purchasers receive large discounts; when only 25% of items are sold, only the upper right portion of the graph is populated.

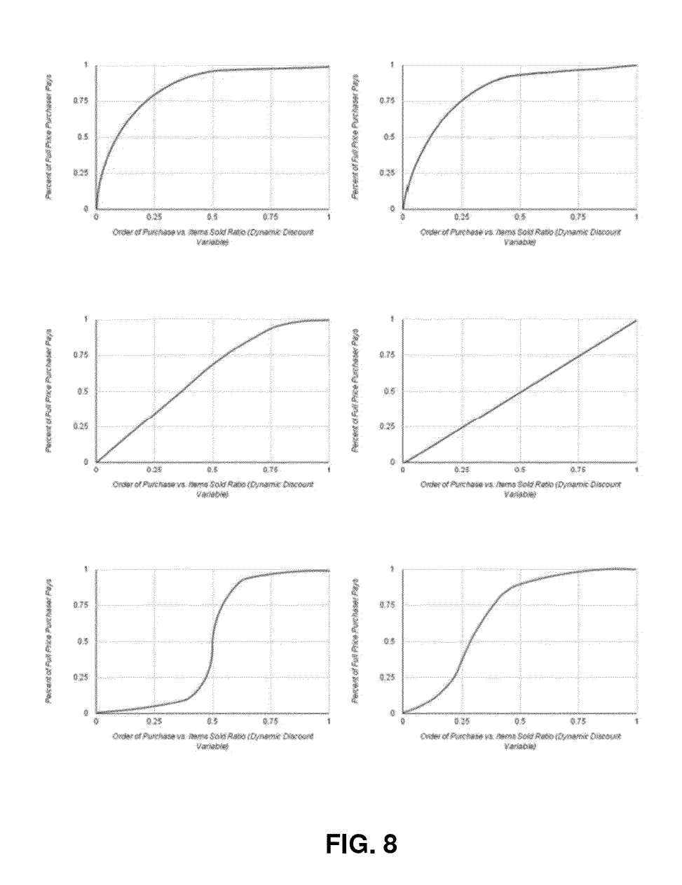

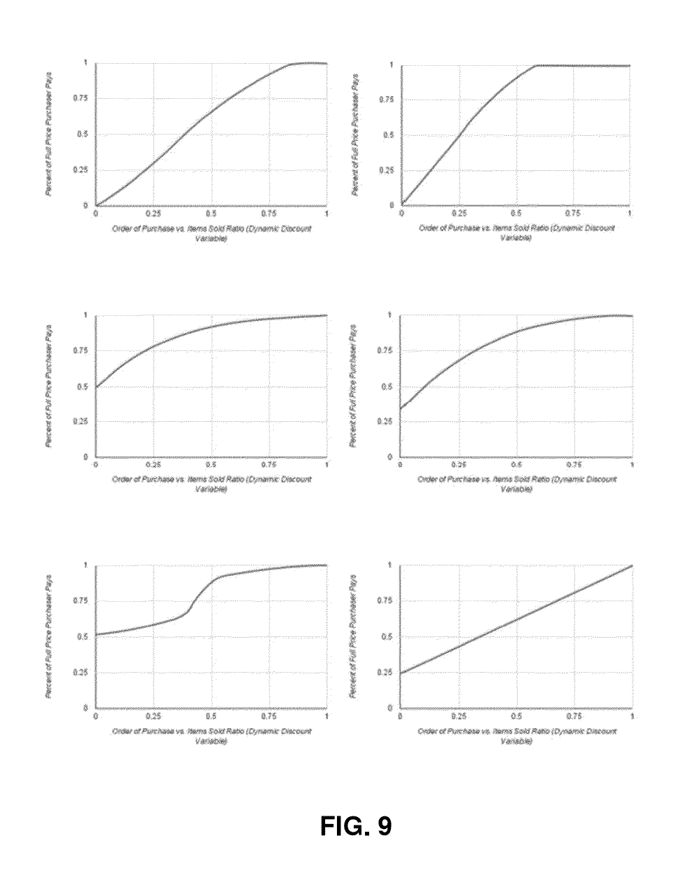

The graphs shown in FIGS. 8 through 9 represent a variety of possible curves, depending on the formula or equation, which a seller may input as a discount parameter in a system of the present invention. It will be appreciated that the curves shown are only intended to illustrative of curves that may used in a system and method of the present invention and are not intended to limit the scope of this disclosure. These curves all represent a method of selling items that get progressively discounted as more purchasers buy in. All the curves, discount amounts, and formulas are just variations on the method. Any formula can be used to generate any of these curves, or other curves desired by the merchant. For example, the curve can be a step curve rather than a smooth curve and may establish tiered discounts. In tiered dynamic discounting, a group of purchasers move up to a larger discount together when a certain value or criteria is reached, such as a certain quantity of items sold. Alternatively, the dynamic discounting can be set up with two or more different curves or formulas for a particular sale. For example, once a customer or group of customers reaches a certain threshold of price, order in line, or point on the curve, the curve changes to a different shape or z-factor. The dynamic discounting method need not be limited to just one curve for a given sale.

It may be preferential to have a cap set on the discount so that the discount does not exceed a certain pre-defined amount, typically defined by the merchant.

According to one aspect of the invention, after each purchase, block of purchases, value of purchases, or time elapsed (e.g. hour, day) since a customer's purchase (which may be defined by the merchant), each customer's discount is recalculated to update the discount given as affected by subsequent purchases.

One example where dynamic group discounting may be particularly useful is for the sale of event tickets. For event organizers, a common problem is seats going unsold resulting in money left on the table and the event being less populated. Dynamic group discounting may entice event goers to purchase tickets early, and then share the presale with others who may be interested in going at a discounted price. Each subsequent person who buys a ticket drives the price of the previous purchasers' tickets down incrementally. The result of this is that the event organizer gets accelerated word-of-mouth buzz for the event, selling more tickets. For a concert, it also means that the artist gets their music out to a larger number of fans.

Another example would be for a product launch. For example, a mobile application (“app” or “apps”) or other software product. If an app developer wants to launch their product at a discount in order to increase interest and sharing, dynamic group discounting may provide an effective and engaging alternative to conventional forms of discounting. The developer could decide that the first 20,000 apps sold would be subject to a dynamic group discounting run, getting the product into thousands of peoples' hands for low cost and encouraging sharing among users.

There may be numerable examples where dynamic group discounting may be beneficial, for example: book presales, albums, prints, test/beta products, services, etc. Dynamic group discounting could be applied to a huge variety of items, as long as they are being sold as a specific or limited number of items, in a limited amount of time, or both as a specific quantity and for a specific amount of time, such as concert/sport/theatre tickets; software or mobile applications, video games, etc.; limited runs of art prints, records, t-shirts, posters, jewelry, clothing, etc.; bundles or packages of services rendered at a discount; downloadable digital goods: e-reader books, music, apps, etc.

Furthermore, there may be many variations on the dynamic discounting method and system disclosed herein. For example, the discount can be set up so that a purchaser's price is affected by each subsequent individual buyer, or by tiers or groups of purchasers, making it more of a threshold type of discounting run. Additionally, the tiers could be either fixed or variable. Fixed would mean that the amount of people required to bump the buyer's discount down remains the same throughout the sale. Variable would mean that the amount of people required could change throughout the sale.

There may also be a variety of options for providing a discount to buyers. For example, a simple refund is provided to the buyer shortly after the close of the sale, such as by refunding a card they paid with, or another method like sending a check or physical payment. A delayed charge system may be utilized. In other words, a buyer would commit to buy at full price or lower (depending on the final discount) and watch his or her price drop during the course of the sale, but his or her payment would not be processed until the end of the sale at which point he or she would be charged the final, lower price. The discount value could be given as a credit towards future purchases or goods with the same merchant. It could also be given as other benefits, such as bonus credit or coupons at other businesses, or extra items (for example, get a T-shirt & CD with concert ticket purchase).

The system and method of the present invention may provide additional incentives for buyers to share the sale when they refer subsequent purchasers. These could be given for each individual referred, or tiers of individuals (e.g. get 3 people to buy and you get an additional discount). Other examples may include: extra rebate rewards (money) from the seller, either fixed or variable for each additional referral; giving an additional discount off the price would affect the price curve; a reward could be given as other incentives such as opportunities to get in on future sales before other buyers, coupons or other merchandise from the same seller or different businesses.

There are also may be variations of the dynamic discounting system and method that would allow a purchaser to jump ahead in line, such as by referring a certain number or quota of individuals defined by the merchant. Also, as incentives for sharing the sale additional rewards may be given to the purchaser in the form of added value to the goods or services received, further advancement of their place in line ahead of other purchasers, or other additional benefits, such as early access to future offers.

According to one aspect of the invention, dynamic discounting can be applied to services where there is not a set quantity of goods or items sold. This is done by basing a purchaser's discount not on a number of items sold (which may not work for services), but based on a value of services sold. For example, the x-axis may represent the dollar value of total services sold, rather than quantity of items sold, so that as it increases the discount for earlier buyers increases. The same type of curves and formulas could be used.

In sum, the present disclosure provides an improved system and method for dynamic discounting to purchasers of goods or services where the discount applied to each individual purchaser's transaction incrementally increases as a function of the number of subsequent purchases or transactions. In other words, the discount each individual purchaser receives may incrementally increase as a function of the purchaser's sequential order of purchase and/or the total items sold. As has been made apparent by the discussion above, the improved system and method may incorporate a multitude of variations and/or additional factors in determining the final price each individual purchaser pays when a particular good and/or service is offered for sale by a merchant according to principles of the present invention.

There is thus disclosed an improved method and system for sellers to market goods and/or services at a discounted price while reducing the seller's risk and maximizing the seller's profit that provides adequate incentive to potential buyers. For example, the improved system and method may provide an incentive for buyers to share and/or promote the sale of a particular product and/or service to increase the overall sales of the product and/or service.

What is claimed is:

1. A system for providing a discount to consumers comprising:
a first input device for receiving seller information from a seller, including seller information relating to a price for a product or a service that is being offered for sale;
a plurality of second input devices for receiving buyer information from a plurality of buyers each of which agrees to pay the price for the product or the service, the plurality of buyers including at least a first buyer and a second buyer; and
a system controller configured for receiving the seller information and the buyer information;
wherein the buyer information includes when the first buyer agreed to pay the price for the product or service and when the second buyer agreed to pay the price for the product or service; and
wherein the system controller is programmed to calculate a discount for at least the first buyer and the second buyer based at least in part on when the first buyer agreed to pay the price for the product or service and when the second buyer agreed to pay the price for the product or service.

2. The system of claim 1, further comprising a third buyer, wherein the system controller is programmed to recalculate the discount for the first buyer and the second buyer based on when the third buyer agreed to pay the price for the product or service.

3. The system of claim 1, wherein the system controller is programmed to use a discount curve to determine the discount for the first buyer and the second buyer.

4. The system of claim 1, wherein the seller information includes the overall discount that will be offered to the plurality of buyers.

5. The system of claim 4, wherein the seller information includes the quantity of the product or the service that will be offered during a sale period.

6. The system of claim 5, wherein the overall discount is dependent on the entire quantity of the product or the service being sold to the plurality of buyers during the sale period.

7. The system of claim 1, wherein the discount is calculated using the curve y=x^{z} where x represents when the plurality of buyers agree to purchase the product or the service plus the number of remaining items divided by the total number of items on sale, and y represents the value of the discount provided to the plurality of buyers.

8. A method of providing dynamic group discounting for the sale of a product or service to a plurality of buyers comprising the steps of:
receiving seller information using a processor configured to communicate the seller information to a plurality of buyers, wherein the seller information includes an offered price for at least one product or service;
providing the offered price for the at least one product or service to a plurality of buyers;
receiving an acceptance to buy the at least one product or service at the offered price from a first buyer;
receiving an acceptance to buy the at least one product or service at the offered price from a second buyer;
wherein the processor is programmed to calculate a discount price for the first buyer after receiving the acceptance to buy the at least one product or service at the offered price from the second buyer such that the first buyer pays a reduced final price for the at least one product or service as compared to the final price paid by the second buyer.

9. The method according to claim 8, further comprising receiving an acceptance to buy the at least one product or service at the offered price from a third buyer, wherein the processor is programmed to recalculate the discount price for the first buyer and calculate a discount price for the second buyer after receiving the acceptance to buy the at least one product or service at the offered price from the second buyer such that the first buyer pays a reduced final price for the at least one product or service as compared to the final price paid by the second buyer and the second buyer pays a reduced final price for the at least one product or service as compared to the final price paid by the third buyer.

10. The method according to claim 9, wherein the discount price is continuously updated and provided to the each of the first, second and third buyers.

11. The method according to claim 9, wherein the first buyer comprises a first group of buyers and the second buyer comprises a second group of buyers.

12. The method according to claim 8, wherein the discount price comprises a refund to the first buyer.

13. The method according to claim 8, wherein an incentive other than the discount price is provided to at least one of the first buyer and the second buyer for referring a subsequent buyer who accepts to buy the at least one product or service at the offered price.

14. The method according to claim 8, wherein the discount price is calculated using the curve y=x^{z} where x represents when the first buyer and the second buyer accept to buy the at least one product or service at the offered price plus the number of remaining items divided by the total number of items on sale, and y represents the value of the discount provided to the first buyer and the second buyer.

15. A method of providing dynamic group discounting based at least in part on when a purchaser agrees to buy a product and/or service comprising the steps of:
receiving input from a seller regarding the sale of a product and/or service;
communicating information based on the input from the seller to a plurality of buyers using a system controller; and
receiving an acceptance to buy the at least one product or service from the plurality of buyers;
wherein the system controller is programmed to calculate a discount price for the plurality of buyers using a discount curve; and
wherein the first buyer of the plurality of buyers receives the largest discount and wherein each subsequent buyer of the plurality of buyers receives a discount that is less than the discount received by the first buyer.

16. The method according to claim 15, wherein at least one of the subsequent buyers can receive a larger discount than the first buyer by referring another person to the sale who agrees to buy the at least one product or service.

17. The method according to claim 15, wherein each of the plurality of buyers agrees to pay full price for the at least one product or service, and wherein each of the plurality of buyers receives a unique discount price depending on when he or she accepted to pay full price for the at least one product or service.

18. The method according to claim 17, wherein each of the plurality buyers are only charged for the purchase of the at least one product or service after the sale of the at least one product or service closes and/or the plurality of buyers has agreed to purchase the quantity of the at least one product or service.

19. The method according to claim 18, wherein each of the plurality of buyers are each charged a unique final price that is equal to the full price minus the unique discount price received by the plurality of buyers.
